(19) United States
(12) Patent Application Publication
(10) Pub. No.: US 2009/0090045 A1
(43) Pub. Date: Apr. 9, 2009

(54) Method and apparatus for monitoring, baiting and exterminating pests

(76) Inventor: Jerry G. Baker, Houma, LA (US)

Correspondence Address: Ted M. Anthony, P.O. Box 3408, Lafayette, LA, 70502, US

(21) Appl. No.: 11/973,541

(22) Filed: Oct. 9, 2007

(51) Int. Cl. A01M 17/00; A01M 1/20

(52) U.S. Cl. 43/132.1; 43/131

(57) ABSTRACT

An apparatus that can be placed into a surface or substrata, such as soil or a wall, to or within baiting and, if desired, exterminating of populations of pests situated or behind or within such surface. In one embodiment, the apparatus comprises a body member that can be anchored into the surface to be monitored, and a removable cap that can be locked in place to prevent access to the body member. If desired, bait can be attached to the bottom of the cap member and inserted within such surface.

### CROSS REFERENCES TO RELATED APPLICATIONS

NONE

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention relates to the monitoring, baiting and/or exterminating of pests including, but not necessarily limited to, termites and/or insects. More particularly, the present invention relates to a method for monitoring, baiting and/or exterminating populations of pests. More particularly still, the present invention relates to an apparatus that can be installed in a surface or substrata, such as the ground or a wall, that will permit access to areas beyond such surface for monitoring, baiting and, if desired, exterminating of populations of pests situated in such areas.

2. Brief Description of the Prior Art

Pests and insects can have significant economic and other impact on society. Termites, in particular, are one type of pest that can have an extremely important economic impact on society. Termites often feed on plant material, generally in the form of wood, leaf litter, or soil. Termites are economically significant as pests because they can cause serious structural damage to buildings, crops and/or plantation forests.

Certain types of termites, commonly referred to as “subterranean termites,” are social insects that live in nests or colonies in soil. Subterranean termites frequently gain access to buildings and/or other structures from such surrounding soil. Termites can enter buildings through wood that is in direct contact with soil by building shelter conduits over or through foundations, and/or by entering directly through cracks or joints in and under foundations.

Subterranean termite “swarmers” can also be blown on or into structures and thereafter establish new colonies on or in proximity therewith. When this occurs, the termites often feed on wood or other cellulosic material of such structures, which can often result in significant damage.

Many different methods for controlling pest such as termites have been developed over the years. One such method involves the application of chemicals directly to soil in the general vicinity of buildings/structures to be protected from termites. When properly performed, such chemical application will ideally result in formation of a chemically-treated soil barrier between a structure and surrounding soil areas. However, this method is typically very labor intensive and can potentially result in environmental contamination to the surrounding area.

Another approach to termite control involves the installation of pest baiting “stations” in the soil in general proximity to a structure to be protected. Once installed, such baiting stations are typically loaded with bait (such as a wooden stick, cellulosic material or other similar material), and thereafter periodically checked for infestation by such termites. Chemicals are then applied to the soil only in the particular areas in which infestation is observed. Although this approach minimizes the amount of chemicals used, existing baiting/treating stations suffer from certain important limitations.

In most cases, existing baiting/treating stations are installed directly into the soil. However, such existing baiting/treating stations are generally not anchored in place, and can be removed with minimal effort. In some cases, even if properly installed, baiting/treating stations may eventually protrude outward and/or become dislodged from the soil as a result of moisture, ground shifting or other conditions.

Moreover, in some cases, such existing baiting/treating stations utilize a base member (which can be a perforated canister or similar structure) and a removable cap that can be fixed in place. Such caps can be easily removed, providing an opportunity for such baiting/treating stations to be tampered with and/or vandalized.

Despite the existence of termite baiting/treating systems in the prior art, there nonetheless exists a need for an apparatus that can be placed into a surface or substrata, such as the ground or a wall, to permit access to areas beyond such surface for monitoring, baiting and, if desired, extermination of populations of pests situated in such areas. The access assembly should be capable of being solidly anchored into the surface to be monitored (such as soil or a wall), and should be inexpensive, and easy to install and use. Additionally, such pest treatment access assembly should include a lockable cap that can be removed only by authorized users and will prevent access by unauthorized users.

### SUMMARY OF THE PRESENT INVENTION

The present invention comprises an access assembly that can be used in connection with the monitoring, baiting and/or exterminating of pests such as termites, insects and the like. The access assembly of the present invention can be placed into a surface or substrata, such as the soil or a wall, to permit access to areas beyond such surface for monitoring, baiting and, if desired, exterminating of populations of pests situated behind or within such surfaces.

In one embodiment, the access assembly of the present invention comprises a substantially cylindrical body member having a top and a bottom. Said body member has a substantially circular upper opening at its top and a substantially circular opening at its bottom, and a substantially cylindrical central bore extending through said body member from said upper opening to said lower opening. In the preferred embodiment, said body member has a larger diameter at its top than at its bottom, resulting in said body member having a slightly conical shape.

At least one extension protrudes radially outward from the outer peripheral surface of said substantially cylindrical body member. In the preferred embodiment, said at least one extension comprises a substantially planar fin member that extends around the entire circumference of said body member. Further, in the preferred embodiment, said at least one planar fin member is oriented perpendicular to the longitudinal axis of the central bore of said substantially cylindrical body member. Alternatively, in another embodiment, said planar fin-like member can be disposed in a spiral orientation along the outer surface of the substantially cylindrical body member.

A flange member is disposed at the top of said cylindrical body member. Said flange member has a larger outer diameter than the outer diameter of said body member, as well as a substantially flat upper surface. Said flange member also has a central opening that is aligned with both the opening at the upper end of said body member, and the central bore that extends through said body member.

The present invention further comprises a removable cap member. In the preferred embodiment, said cap member has a substantially circular outer profile, and is sized to fit within the central opening of said flange member. In the preferred embodiment, said cap member further comprises at least one extension or cleat that extends radially outward from the side of said cap member. A keyhole or other receptacle for receiving a key can be located on said cap member; in the preferred embodiment of the present invention, a key receptacle is situated on the upper surface of said cap member.

In the preferred embodiment, said flange member has an inner ledge that extends substantially around the entire circumference of the central opening of said flange member. Said inner ledge defines a smaller inner diameter than the diameter of the central opening of said flange member. At least one notch extends through said inner ledge of said flange member. Said cap member, which is generally sized to fit within the central opening of said flange member, can be placed within said central opening of said flange member such that said at least one cleat is aligned with said at least one notch. In this configuration, said at least one cleat is permitted to traverse within said at least one notch which, in turn, allows said cap member to sink or recede within the central opening of said flange member. In the preferred embodiment, a key can be inserted into said cap, and said cap can be rotated. As said cap is rotated, the upper surface of said at least one cleat engages against the lower shoulder of the inner ledge, thereby securing said cap in place. Similarly, said key can be used to rotate said cap (in most cases, in the opposite direction) until said at least one cleat is aligned with said at least one notch, thereby permitting said cap to be removed from the central opening of said flange member.

In the preferred embodiment, the lower surface of said cap member defines a recess for attaching bait. In most cases, such bait is a rectangular stick of wood, cellulosic material or the like. Said bait can be affixed to the lower surface of said cap member and placed inside the central bore of said body member. If desired, the cap member can be locked in place; said cap member can be removed as desired to monitor said bait and determine whether pests are present.

The access assembly of the present invention can be used to monitor and, if necessary, provide easy access to pests situated behind or within a surface. For ease of reference, this discussion will focus on monitoring of pest populations in soil such as, for example, subterranean termites. However, it is to be observed that said invention can also be used to monitor and provide access behind other surfaces, such as walls, ceilings, roofs and the like.

The body member of the present invention is inserted into the soil to be monitored. The fin-like extensions that protrude radially outward from the outer surface of the body member serve to securely anchor the body member in the soil. As a result, said body member cannot be easily pulled out of or removed from the soil, and will not protrude upward and/or otherwise become dislodged from the soil as a result of moisture, ground shifting or other conditions.

In the preferred embodiment, the flange member situated at the upper end of the body member is located at the surface of the soil and has a beneficially low profile. The cap member can be inserted into the opening of said flange member and locked in place to prevent access to the central bore of said body member. If desired, bait can be affixed to the underside of said cap. In this configuration, said bait would be inserted into the soil within the central bore of the body member.

In an alternative embodiment of the present invention, said substantially cylindrical body member does not include said ring-like flange member at its upper end. Rather, a sleeve member having a ring-like flange is provided. Said sleeve member has an inside diameter that is slightly larger than the outside diameter of said body member, thereby permitting said sleeve to slip over the upper portion of said body member. This alternative embodiment of the present invention permits the sleeve member and accompanying cap assembly to interchangeably work with multiple body members anchored in different locations.

The present invention also provides methods for either partially or completely implanting pest access assemblies in areas to be monitored. In preferred embodiments, such methods comprise the steps of identifying area(s) suspected of suffering from pest infestation and then installing one or more access assemblies at locations proximate to such area(s).

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts an exploded side perspective view of the access assembly of the present invention.

FIG. 2 depicts an exploded side perspective view of the access assembly of the present invention loaded with a bait stick.

FIG. 3 depicts an exploded side perspective view of an alternative embodiment the access assembly of the present invention.

FIG. 4 depicts a perspective view of the bottom surface of a cap member of the present invention.

### DETAILED DESCRIPTION OF A PREFERRED EMBODIMENT OF THE INVENTION

The present invention comprises an access assembly 10 that can be used in connection with the monitoring, baiting and/or extermination of pests such as termites and the like.

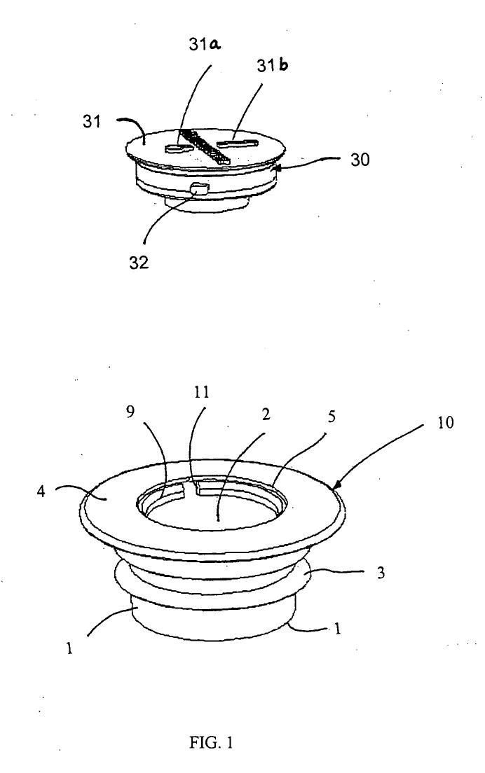

Referring to the drawings, FIG. 1 depicts an exploded perspective view of access assembly 10 of the present invention. Access assembly 10 comprises substantially cylindrical body member 1. Said body member 1 has an upper end (obstructed from view in FIG. 1) and a lower end 1b, as well as substantially cylindrical openings at said upper and lower ends. Substantially cylindrical central bore 2 extends from said openings through body member 1. In the preferred embodiment, body member 1 has a larger diameter at its upper end than at its bottom end, thereby giving body member 1a slightly conical shape.

At least one fin extension 3 extends radially outward from the outer peripheral surface of body member 1. In the preferred embodiment, said at least one fin extension 3 comprises a substantially planar member that extends substantially around the entire circumference of said body member 1. Further, in the preferred embodiment, said at least one planar fin extension 3 is oriented perpendicular to the longitudinal axis of central bore 2 extending through cylindrical body member 1. Alternatively, it is to be observed that said at least one planar fin extension 3 can be in a spiral pattern along the outer surface of body member 1.

Still referring to FIG. 1, flange member 4 is disposed at the upper end of substantially cylindrical body member 1. In the preferred embodiment, flange member 4 has a substantially flat upper surface and a larger outside diameter than the outside diameter of said body member 1, as well as a central opening 5 that is generally aligned with central bore 2 extending through said body member 1.

Access assembly 10 of present invention further comprises cap member 30. In the preferred embodiment, said cap member 30 has a substantially circular shape, and is generally sized to fit within central opening 5 of flange member 4. In the preferred embodiment, cap member 30 further comprises at least one cleat 32 that extends radially outward from the side of cap member 30. In the preferred embodiment of the present invention, key receptacles 31a and 31b are situated on substantially flat upper surface 31 of cap member 30.

Still referring to the preferred embodiment depicted in FIG. 1, said flange member has an inner ledge 9 that extends substantially around the entire circumference of the inner surface of said flange member 4. At least one notch 11 extends through said inner ledge 9. Said cap member 30, which is generally sized to fit within the central opening 5 of said flange member 4, can be placed within said central opening of said flange member 4 so that said at least one cleat 32 is aligned with said at least one notch 11. In this configuration, said at least one cleat 32 is permitted to travel within said at least one notch 11. When said at least one cleat 32 is not aligned with said at least one notch 11, said cap member 30 (and said at least one cleat 32, in particular) is obstructed by inner ledge 9 and is prevented from fully seating within central opening 5 of flange member 4. However, when said at least one cleat 32 is aligned with said at least one notch 11, said cap member 30 is permitted to fully recede and seat within central opening 5 of said flange member 4.

In the preferred embodiment, when cap member 30 is fully seated, a key can be inserted into said receptacles 31a and 31b of cap member 30, and said cap member 30 can be rotated. As said member 30 is rotated, the upper surface of said at least one cleat 32 engages against the lower shoulder of inner ledge 9, thereby securing said cap member 30 in place. Similarly, said key can be used to rotate said cap member 30 (in most cases, in the opposite direction) until said at least one cleat 32 is aligned with said at least one notch 11, thereby permitting said cap member 30 to be removed from the central opening of said flange member 4.

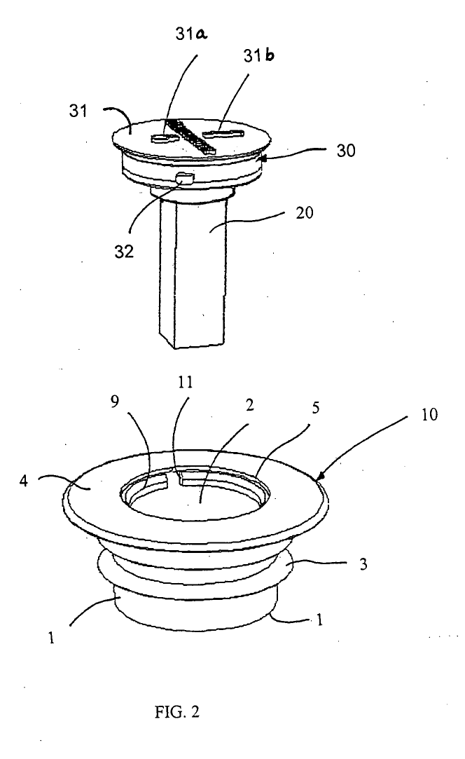

FIG. 2 depicts an exploded side perspective view of the access assembly of the present invention with bait stick 20 installed. In the preferred embodiment, the lower surface of said cap member 30 (not shown in FIG. 2) defines a recess for receiving bait stick 20. In most cases, such bait is in the form of a rectangular stick of wood or other cellulosic material or the like, such as bait stick 20. Said bait stick 20 can be affixed to the lower surface of said cap member 30 and placed inside central opening 5 of flange member 4 and central bore 2 of body member 1. If desired, cap member 30 can be locked in place; said cap member 30 can be removed as desired to monitor said bait stick 20 and determine whether termites or other pests are present.

When cap member 30 is to be removed, a key is inserted into keyhole receptacles 31a and 31b of said cap member 30, said key is turned counterclockwise until said keyhole receptacles are aligned with an unlocked position indicator on the upper surface of said ring-like flange member 4. Said cap member 30 can be removed, thereby permitting access to the central bore 2 of said body member (via the opening 5 of said flange member 4).

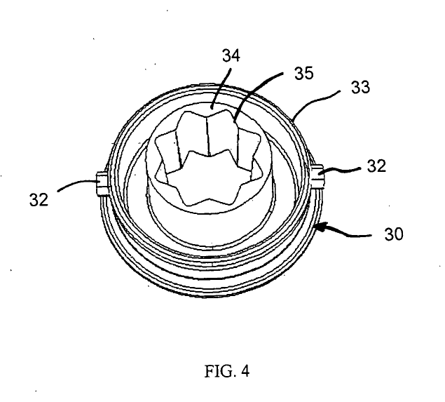

FIG. 4 depicts a perspective view of the bottom surface of cap member 30 of the present invention. Cap member 30 further comprises substantially cylindrical body member 33; substantially cylindrical body member 33 is beneficially sized to fit within the inner diameter formed by inner ledge 9 that extends substantially around the entire circumference of the inner surface of said flange member 4 (as depicted in FIG. 1). Cleats 32 extend radially outward from the outer surface of body member 33. Bait receptacle 34 extends from the lower surface of cap member 30, ideally within body member 33. In the preferred embodiment, bait receptacle 34 includes a star-like recess 35 for receiving and securing bait, such as bait stick 20 depicted in FIG. 1.

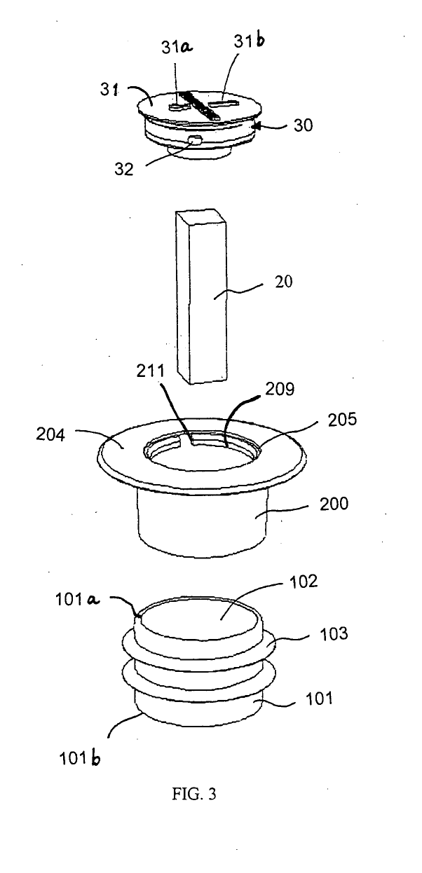

FIG. 3 depicts an exploded perspective view of an alternative embodiment of the access assembly of the present invention. Referring to FIG. 3, substantially cylindrical body member 101 does not include a ring-like flange (such as flange member 4 of the alternative embodiment of the present invention depicted in FIG. 1). Substantially cylindrical body member 101 has an upper end 101a and a lower end 101b, as well as substantially cylindrical openings at said upper and lower ends. Substantially cylindrical central bore 102 extends from said openings through body member 101. If desired, body member 101 may have a larger diameter at its upper end than at its bottom end, thereby giving body member 101 a slightly conical shape.

Still referring to FIG. 3, at least one fin extension 103 extends radially outward from the outer peripheral surface of body member 101. In the preferred embodiment, said at least one fin extension 103 comprises a substantially planar member that extends substantially around the entire circumference of said body member 101. Further, in the preferred embodiment, said at least one planar fin extension 103 is oriented perpendicular to the longitudinal axis of central bore 102 extending through cylindrical body member 101. Alternatively, it is to be observed that said at least one planar fin extension 103 can be in a spiral pattern along the outer surface of body member 101.

Instead of having a flange member permanently attached to body member 101, sleeve member 200 having a flange member 204 at its upper end is provided. Still referring to the preferred embodiment depicted in FIG. 3, said flange member 204 has an inner ledge 209 that extends substantially around the entire circumference of the inner surface of said flange member 204. At least one notch 211 extends through said inner ledge 209. Said cap member 30, which is generally sized to fit within the central opening 205 of said flange member 204, can be placed within said central opening of said flange member 204 so that said at least one cleat 32 is aligned with said at least one notch 211.

In this configuration, said at least one cleat 32 is permitted to travel within said at least one notch 211. When said at least one cleat 32 is not aligned with said at least one notch 211, said cap member 30 (and said at least one cleat 32, in particular) is obstructed by inner ledge 209 and is prevented from fully seating within central opening 205 of flange member 204. However, when said at least one cleat 32 is aligned with said at least one notch 211, said cap member 30 is permitted to fully recede and seat within central opening 205 of said flange member 204.

In the embodiment of the invention depicted in FIG. 3, sleeve member 200 (and accompanying cap assembly 30) can interchangeably work with multiple body members 101 anchored in different locations.

In operation, the access assembly of the present invention can be used to monitor and, if necessary, provide easy access to pests situated behind or within a surface or strata. For ease of reference, this discussion will focus on monitoring of pest populations in soil such as, for example, subterranean termites. However, it is to be observed that said invention can also be used to monitor and provide access behind other surfaces, such as walls, ceilings, roofs and the like.

Referring to the embodiment of the present invention depicted in FIG. 1, body member 1 is buried into soil to be monitored. Planar fin extensions 3 that protrude from the outer surface of body member 1 serve to securely anchor body member 1 in the soil to be monitored. As a result, body member 1 cannot be easily removed from the soil, and it will not protrude upward and/or become dislodged from the soil as a result of moisture, ground shifting or other conditions.

In the preferred embodiment, flange member 4 is situated at the upper end of the body member is located at or near the surface of the soil. In most applications, flange member 4 is installed so that it is substantially flat against the surface of the soil. Cap member 30 can be inserted into opening 5 of flange member 4 and locked in place to prevent access to central bore 2 of said body member 1. If desired, bait 20 can be affixed to the underside of said cap member 30. In this configuration, said bait 20 would be inserted into the soil within the central bore of body member 1.

In some instances, access assembly 10 of the present invention can be used to provide access behind walls or other surfaces. In such cases, cap member 30 can be removed to allow a camera, listening device or other similar apparatus into the area behind such surface.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An apparatus for accessing areas beyond a surface comprising:
a. a substantially cylindrical body having a top, a bottom and a bore extending through said body from said top to said bottom;
b. at least one fin member extending radially outward from the outer surface of said body;
c. a flange having an opening disposed at the upper end of said body, wherein said opening is aligned with the bore of said body;
d. a cap member removably received within the opening of said flange; and
e. means for selectively locking and unlocking said cap member within the opening of said flange.

2. The apparatus of claim 1, wherein said at least one fin member extends substantially around the entire circumference of said body.

3. The apparatus of claim 1, wherein said at least one fin member comprises a planar member oriented substantially perpendicular to the longitudinal axis of said body.

4. The apparatus of claim 1, wherein said means for selectively locking and unlocking said cap member within the opening of said flange further comprises:
a. at least one cleat extending from the side of said cap member;
b. a inner ledge extending substantially around the circumference of the opening of said flange; and
c. at least one notch disposed through said inner ledge.

5. The apparatus of claim 4, further comprising:
a. a receptacle disposed on said cap; and
b. a key that mates with the receptacle of said cap.
